(19) United States
(12) Patent Application Publication
(10) Pub. No.: US 2026/0307474 A1
(43) Pub. Date: Oct. 8, 2026

(54) Device for sealing an opening of a tank, tank comprising an interface for receiving the device

(71) Applicant: Reutter GmbH, Bischofshofen (AT)

(72) Inventor: Franz Rohrmoser, Großarl (AT)

(21) Appl. No.: 19/631,302

(22) Filed: Mar. 27, 2026

(30) Foreign Application Priority Data
Apr. 2, 2025 (DE) 102025112 881.2

(51) Int. Cl. B60K 15/04

(52) U.S. Cl. CPC B60K 15/0406; B60K 2015/0451

(57) ABSTRACT

A device for sealing an opening of a tank, and a tank including an interface configured to receive the device, are provided. The device includes a housing, a seal configured to seal the opening via the interface, a seal carrier configured to receive the seal and movable axially relative to the housing, and a spring arranged between the housing and the seal carrier to urge the seal against the interface. A pressure ring is configured such that, when the housing rotates relative to the pressure ring, the housing moves axially relative to the seal carrier to vary the spring force applied to the seal. In some embodiments, the pressure ring engages a hooked portion of the interface so that relative rotation between the housing and the pressure ring produces axial movement while maintaining sealing engagement.

### TECHNICAL FIELD

This disclosure relates to a device for sealing an opening of a tank and to a tank comprising an interface for receiving the device.

### BACKGROUND

Closure covers for sealing tanks, for example for liquids or gases, seal an opening of the tank to prevent a medium in the tank from unintentionally escaping. In known systems, a pressure build-up inside the tank acts against a spring force of the closure cover, which correlates, for example, with a contact force between a seal and the opening. With known closure covers, the pressure build-up acts against the full effective diameter of the closure cover. This pressure build-up reduces the spring force, which can lead to a lack of tightness or leaks at the opening. To counteract this, the spring force on the closure cover is increased, which in turn provides the necessary torque to screw the cover onto and unscrew it from the opening. These closure covers often leak or cannot be assembled without tools.

### SUMMARY

In some applications, it is desirable to provide a tank closure cover in which a spring force, and thus compression of a seal, is substantially maintained or remains substantially constant despite pressure build-up or pressure fluctuations in the tank, so that tightness and ease of assembly of the closure cover on an opening of the tank are improved and are substantially independent of pressure within the tank.

A device for sealing an opening of a tank, wherein the opening comprises an interface configured to receive the device, comprises: a housing; a seal configured to seal the opening via the interface; a seal carrier configured to receive the seal and at least axially movable relative to the housing; a spring arranged between the housing and the seal carrier and configured to press the seal against the interface by a spring force acting on the seal carrier in an axial direction; and a pressure ring configured to move the housing axially relative to the seal carrier when the housing rotates relative to the pressure ring such that the spring force varies to press the seal against the interface.

In the present context, the term "tank" in particular includes containers configured to receive liquids or gases. It is also conceivable that the tank is configured to hold solids, for example in the form of granules or pellets. The tank can be a liquid container. The tank can, for example, be a tank of a vehicle, such as a motor vehicle, which is configured to receive a fuel for the vehicle or alternative consumables for the vehicle. Alternative consumables include, for example, media used for exhaust-gas aftertreatment, cooling or for the vehicle's braking system.

In the present context, “axial” describes a direction that is, for example, an opening direction or a direction in which the device is inserted into or removed from the opening. This direction describes, for example, a direction orthogonal to an imaginary opening plane. “Axial” describes, for example, a direction relative to the device itself in which an axis of rotation is oriented, about which the device is rotated in order to screw it onto or unscrew it from the opening or interface. An axial movement, for example, is a movement along or parallel to a main axis of the device. The main axis is, for example, the axis of rotation about which the device is rotated in order to screw it on or unscrew it. In the present context, an “axial direction” describes an axially oriented direction. In the present context, the terms "screw on" and "unscrew" and related terms refer to screwing the device onto the opening to close the opening and unscrewing the device from the opening to open the opening.

The pressure ring, which causes relative movement between the housing and the seal carrier, can allow the device to be configured such that the seal carrier is substantially completely surrounded by pressure inside the tank. Thus, the seal carrier can be substantially entirely located within a pressure system of the tank. This can make the spring force acting between the housing and the seal carrier, which correlates with the contact pressure between the seal and the interface, more robust and less sensitive to pressure or pressure fluctuations inside the tank, and in some embodiments substantially independent of such pressure or pressure fluctuations. The contact pressure between the seal and the interface can characterize the tightness of the opening closed by the device.

Since the contact pressure can be substantially independent of the pressure inside the tank, the spring can have simpler dimensions and lower spring forces can be used. Thus, the device can be mounted with a torque that remains substantially constant and is primarily influenced by the controllable or specifiable spring force.

The pressure ring can also allow the device to be configured such that the seal carrier is arranged to rotate relative to the housing. This can reduce or prevent sliding friction between the seal and the interface, which might otherwise occur when the device is rotated into engagement with or out of engagement from the opening, especially above a certain contact pressure. This can protect the seal and reduce the torque required to install or remove the device.

In some embodiments, the pressure ring comprises at least one engagement portion extending radially outward and configured to engage a hooked portion of the interface by rotation of the pressure ring. In the present context, “radial” describes, for example, a direction that is orthogonal to the axial direction and is oriented toward or away from the main axis. In the present context, "outward" means that the radial direction is oriented away from the main axis. In this context, a radial direction describes a direction that is radially oriented.

In some embodiments, the at least one engagement portion is configured to stop rotation of the pressure ring when the at least one engagement portion comes into contact with a stop incorporated in the hooked portion so that the housing rotates relative to the pressure ring. This allows the rotation of the housing relative to the pressure ring to be achieved in a space-saving and production-efficient manner. This results in a movement sequence of the device, for example when the device is rotated into engagement with the opening, in which the device is first inserted at or into the opening. In a first portion, the entire device together with all the individual parts thereof is rotated so that the at least one engagement portion engages with the hooked portion, similar to a bayonet fitting. If the at least one engagement portion is in contact with the stop, rotation of the pressure ring is prevented or stopped. If the device continues to rotate in a second portion of the movement sequence, the pressure ring rotates relative to the housing, since the rotation of the pressure ring is blocked by the stop. The previously described movement sequence occurs, for example, in reverse when the device is unscrewed.

The device may comprise a locking mechanism fixed to the housing, for example in an interlocking manner, and configured to axially couple the pressure ring to the housing. The locking mechanism can reduce the complexity of the device, since, for example, no undercuts need to be provided in the housing. Assembly of the device can also be simplified, since, for example, the spring, the seal carrier, and the pressure ring can be placed on the housing and held in position, in particular axially, by subsequently fixing the locking mechanism to the housing. Due to the axial coupling between the locking mechanism and the pressure ring, the relative axial movement between the housing and the seal carrier can also be facilitated by the locking mechanism.

In some embodiments, the locking mechanism comprises at least one locking pin extending radially outward and axially coupling the locking mechanism to the pressure ring. The locking pin reduces the complexity of the design of the device and the design of the interface. The locking pin allows for efficient and space-saving axial coupling between the pressure ring, the locking mechanism and therefore also the housing.

In some embodiments, the engagement portion has an axially oriented contact surface, and the at least one locking pin at least partially radially overlaps the at least one engagement portion and contacts the contact surface, wherein the contact surface comprises a ramp with an axial slope, and wherein the at least one locking pin moves tangentially along the contact surface and over the ramp when the housing rotates relative to the pressure ring in order to move the housing axially relative to the seal carrier and vary the spring force. In the present context, “tangential” describes a direction that is orthogonal to the radial direction. The contact surface comprising the ramp can allow the housing, to which the locking mechanism is fixed, to move axially relative to the seal carrier in a space-saving manner such that the spring between the seal carrier and the housing is compressed and the spring force varies. The slope can be designed or oriented such that the spring is compressed when the device is rotated into engagement with the opening, thereby increasing the spring force, which increases the contact pressure between the seal and the interface.

In some embodiments, the contact surface has a snap-on bead at one end of the ramp, over which the at least one locking pin can be moved, in particular when the device is moved into a closed position. In the present context, the “closed position” describes a position of the device on the opening in which the device is screwed on up to a predetermined stop or end and seals the opening. The snap-on bead can provide feedback indicating that the device has reached its closed position. When the device is screwed on, from the point of contact between the at least one engagement portion and the stop of the hooked portion, the locking pin is moved via the contact surface as the device continues to turn and snaps in at a specific point over the snap-on bead, thus generating, for example, an acoustic click. This improves the handling of the device for the user.

In some embodiments, the seal is configured to seal the opening axially via the interface and radially via the housing. This can improve sealing of the opening and can allow the seal carrier to be arranged in a substantially pressure-neutral manner with respect to the pressure inside the tank so that substantially no forces induced by the pressure inside the tank act thereon.

In some embodiments, the device comprises a cover coupled to the housing, in particular by a coupling, in order to transmit rotational movement of the cover to the housing. The cover can protect the device from external influences and improve handling for the user.

A tank comprises an opening having an interface, wherein the interface is configured to receive the device in order to seal the opening.

Further features and details are set forth in the following description, in which exemplary aspects of the present disclosure are described with reference to the drawings. The features described in the claims, the description, and the drawings may be used individually or in any suitable combination.

### BRIEF DESCRIPTION OF THE DRAWINGS

Further advantages and aspects of the present disclosure will be apparent from the claims and from the following description of exemplary aspects of the present disclosure, which are explained below with reference to the figures. Like reference numerals refer to like and functionally corresponding elements throughout the drawings. In the drawings:

FIG. 1A shows a schematic sectional view of a device for sealing an opening of a tank in an inserted position;

FIG. 1B shows a schematic sectional view of the device in a hooked position;

FIG. 1C shows a schematic sectional view of the device in a closed position;

FIG. 2A shows a schematic partially sectional view of the device in the hooked position;

FIG. 2B shows a schematic partially sectional view of the device in the closed position;

FIG. 3A shows a schematic bottom view of the device in the inserted position;

FIG. 3B shows a schematic bottom view of the device in the hooked position; and

FIG. 3C shows a schematic view of the device in the closed position.

### DETAILED DESCRIPTION

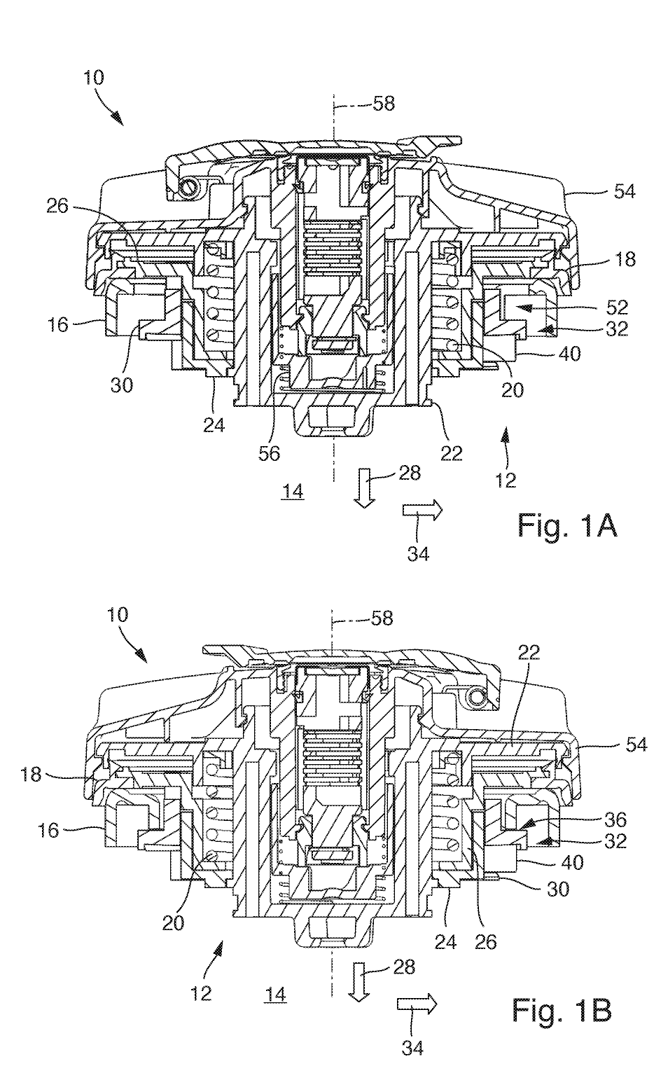

FIG. 1A shows a sectional view of a device 10 for sealing an opening 12 of a tank 14 in an inserted position. The opening 12 comprises an interface 16 which is configured to receive the device 10. The device 10 is, for example, a closure or a sealing cap for the tank 14.

In the present context, the “inserted position” describes a position of the device 10 in which it is loosely inserted into the interface 16 or the opening 12. Accordingly, the inserted position shows a state of the device 10 in which it does not seal the opening 12. The state of the device 10 in the inserted position also corresponds, for example, to a state of the device 10 in which it is completely detached from the tank 14 or the opening 12.

The device 10 comprises a housing 22, which, for example, represents the main body of the device 10 on which further individual parts are arranged. The device 10 comprises a seal 18 configured to seal the opening 12 via the interface 16. The seal 18 is in contact with the interface 16 and is pressed against the interface 16, or against a sealing surface of the interface 16, in particular by a predetermined contact pressure or a predetermined contact force in order to seal the opening 12. The device 10 comprises a seal carrier 26 configured to receive the seal 18. The seal 18, for example, is fixed to the seal carrier 26. The seal carrier 26 is movable at least axially 28 relative to the housing 22.

It may be provided that the seal carrier 26 is also arranged so as to be rotatably movable relative to the housing 22, for example as soon as internal friction between individual parts of the device 10 has been overcome. It is also conceivable that the rotational movement between the housing 22 and the seal carrier 26 is possible within a predetermined angular range due to internal mechanical stops.

The device 10 comprises a spring 20 arranged between the seal carrier 26 and the housing 22 and configured to press the seal 18 against the interface 16 by a spring force acting on the seal carrier 26 and oriented, in particular, axially 28. The spring force acts between the housing 22 and the seal carrier 26 and is transferred to the seal 18 via the seal carrier 26.

The device 10 comprises a pressure ring 30 configured to move the housing 22 axially 28 relative to the seal carrier 26 when the housing 22 rotates relative to the pressure ring 30 so that the spring force varies in order to press the seal 18 against the interface 16. For example, due to internal friction, the pressure ring 30 moves as the device 10 rotates until the movement of the pressure ring 30 is blocked. This blocking results in a relative rotational movement between the housing 22 and the pressure ring 30 when the device 10 continues to turn. This relative rotation ensures that the housing 22 moves axially relative to the seal carrier 26, thereby compressing or relaxing the spring 20 and varying the spring force. In some embodiments, the pressure ring 30 is connected to the seal carrier 26, for example in an interlocking manner, such that substantially no relative rotation is possible therebetween.

In some embodiments, the device 10 comprises a locking mechanism 24 fixed to the housing 22, for example in an interlocking manner, and configured to axially couple the pressure ring 30 to the housing 22. In the example shown, the locking mechanism 24 is firmly coupled to the housing 22 and the seal carrier 26 is pressed against the locking mechanism 24 and thus against the housing 22, for example by a preload of the spring 20. The locking mechanism 24 may allow for a simple structure of the device 10, for example by allowing the spring 20, the seal carrier 26, and the pressure ring 30 to be first placed onto the housing 22, with the locking mechanism 24 then closing and holding the structure together. The seal 18, the seal carrier 26, the pressure ring 30, the locking mechanism 24 and the housing 22 can be substantially the shape of a ring or cylinder around a main axis 58 so that the device 10 can, for example, seal a round opening 12.

FIG. 1B shows a sectional view of the device 10 in a hooked position. The hooked position can, for example, be described as an intermediate position. The device 10 is rotated from the inserted position until it reaches the hooked position. In the present context, the “hooked position” is characterized by the fact that if the device 10 continues to turn beyond the hooked position, rotation of the pressure ring 30 is blocked. Accordingly, this results in a relative rotation between the housing 22 and the pressure ring 30 when the rotation continues.

In some embodiments, the pressure ring 30 comprises at least one engagement portion 32 extending radially outward and configured to engage a hooked portion 36 of the interface 16 by rotation of the pressure ring 30. In some embodiments, the pressure ring 30 comprises at least two opposing engagement portions 32. This results in an improved flow of force between the individual parts of the device 10 and prevents the individual parts from tilting relative to one another. Accordingly, the interface 16 can also comprise at least two, in particular opposing, hooked portions 36. The hooked portion or hooked portions 36 can be configured such that the engagement portion or engagement portions 32 engage therein, similar to a bayonet closure. For the sake of simplicity, the terms “hooked portion 36” and “engagement portion 32” are used in the singular below; however, this does not preclude the possibility that a plurality of engagement portions 32 or hooked portions 36 may be provided.

In some embodiments, the engagement portion 32 is configured to stop rotation of the pressure ring 30 when the engagement portion 32 comes into contact with a stop 38 incorporated in the hooked portion 36 so that the housing 22 rotates relative to the pressure ring 30. The individual parts of the device 10, in particular the housing 22, the seal carrier 26, the locking mechanism 24 and the pressure ring 30, turn together with the device 10 until the pressure ring 30 comes into contact with the stop 38 of the hooked portion 36 in the hooked position. It may be provided that axial clearance is provided between the interface 16 and the seal 18 so that the seal 18 does not rub against the interface 16 when screwed into the hooked position.

FIG. 1C shows a sectional view of the device 10 in a closed position. In the closed position, the device 10 is screwed onto the opening 12 and seals it. In the closed position, the seal 18 is pressed against the interface 16 with a contact force to seal the opening 12. FIG. 1C shows, in comparison to FIG. 1A and 1B, a gap between the seal carrier 26 and the locking mechanism 24 or the housing 22. This gap is created by the axial movement between the housing 22 or the locking mechanism 24 and the seal carrier 26 relative to each other. This compresses the spring 20 and accordingly presses the seal 18 against the interface 16 with the contact force. The contact force or a profile of the contact force can be specified, for example, by dimensioning the spring 20.

If the device 10 continues to turn or rotate beyond the hooked position, the pressure ring 30, and for example also the seal carrier 26 together with the seal 18, stops at the stop 38 while the housing 22 and the locking mechanism 24 continue to turn. This results in the housing 22 rotating relative to the pressure ring 30, and the housing 22 is moved axially relative to the seal carrier 26 and, for example, pushed deeper into the tank 14 and through the opening 12, while the seal 18 is prevented from moving axially by the interface 16. Accordingly, the seal 18 is pressed against the interface 16 depending on the varying spring force.

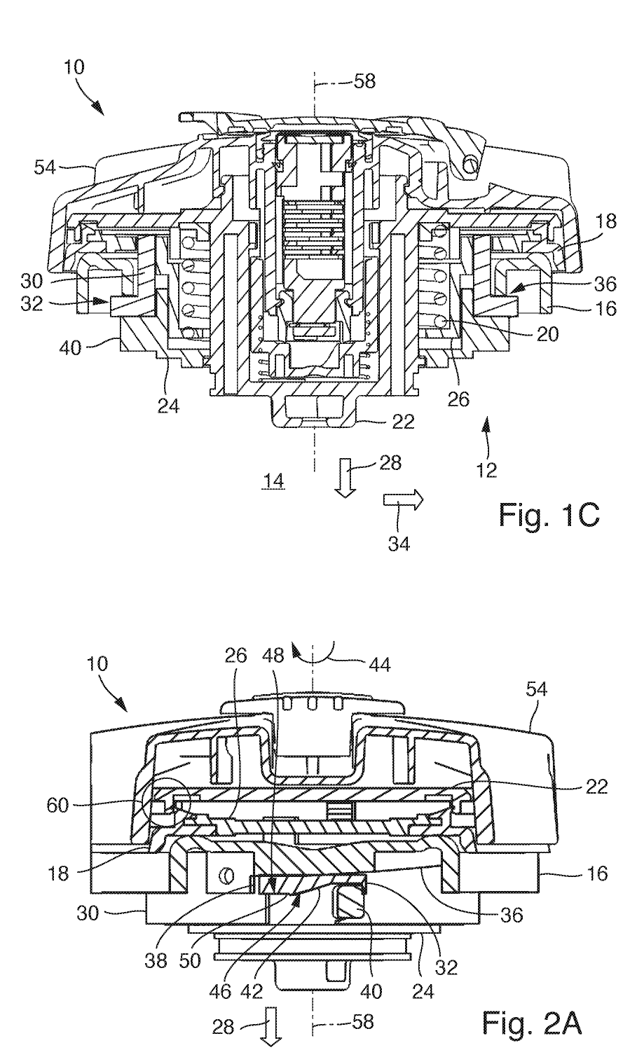

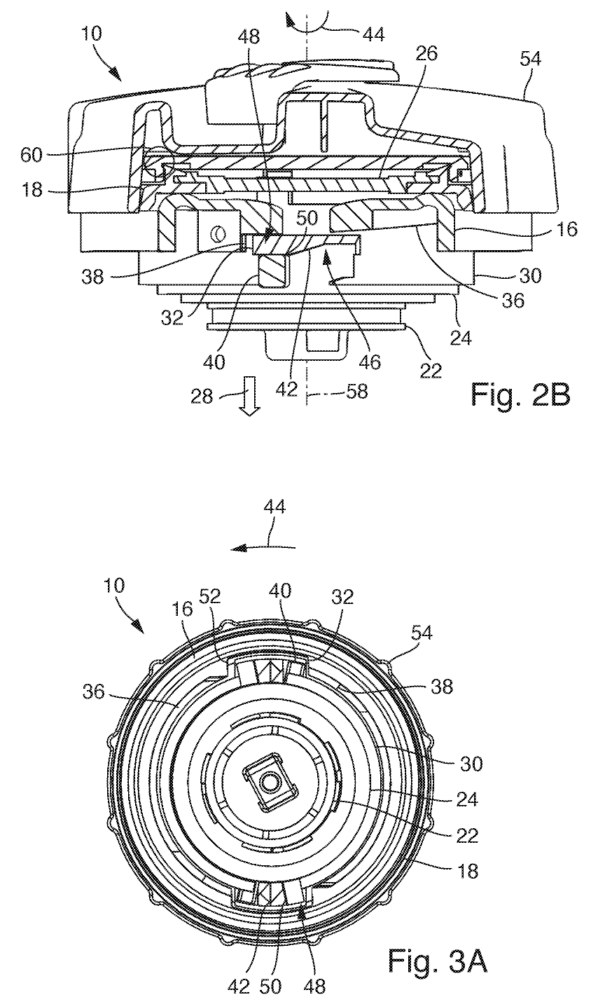

FIG. 2A shows a partially sectional view of the device 10 in the hooked position. The engagement portion 32 of the pressure ring 30 is in contact with the stop 38 of the hooked portion 36 of the interface 16.

In some embodiments, the locking mechanism 24 comprises at least one locking pin 40 extending radially 34 outward and coupling the locking mechanism 24 axially 28 to the pressure ring 30. In the following, the term “locking pin 40” is used in the singular, but this does not exclude the possibility that a plurality of locking pins 40 may be provided. It may be provided that a number of engagement portions 32 and/or hooked portions 36 and/or locking pins 40 are identical.

In some embodiments, the engagement portion 32 has an axially 28 oriented contact surface 46, and the at least one locking pin 40 at least partially radially overlaps the at least one engagement portion 32 and contacts the contact surface 46. The contact surface 46 has a ramp 42 with an axial slope, wherein the at least one locking pin 40 moves tangentially 44 along the contact surface 46 and over the ramp 42 as the housing 22 rotates relative to the pressure ring 30 in order to move the housing 22 axially relative to the seal carrier 26 and vary the spring force. Due to the slope in the axial direction, an offset between the pressure ring 30 and the locking mechanism 24 or the housing 22 increases as the locking pin 40 moves over the ramp 42.

FIG. 2B shows a partially sectional view of the device 10 in the closed position. The locking pin 40 has moved over the ramp 42 by continuing to turn the device 10 and stopping the pressure ring 30 at the stop 38, thus varying or increasing the spring force. It may be provided that the locking pin 40 is blocked in the closed position by a portion of the stop 38 or by a stop 38 provided on the pressure ring 30. This allows a defined closed position to be specified, beyond which the housing 22 and the locking mechanism 24 or the device 10 cannot be turned.

Starting from the hooked position, as the device 10 continues to rotate, the locking mechanism 24 is moved over the ramp 42 of the pressure ring 30 to an end point, for example the stop 38. The locking mechanism 24 thereby pulls the housing 22 axially toward the interface 16, while the seal 18 and the seal carrier 26 are pressed against the interface 16 by the spring 20.

In some embodiments, the contact surface 46 has a snap-on bead 50 at one end 48 of the ramp 42, over which the at least one locking pin 40 can be moved, in particular when the device 10 moves into its closed position. The locking pin 40 snaps in over the snap-on bead 50 when the device 10 reaches the closed position. The snap-on bead 50 can provide feedback when the closed position is reached and can help retain the closed position until the device 10 is actuated again, for example by being unscrewed. The actuating torque that occurs during screwing or unscrewing is controllable by the spring 20 and is substantially not influenced by the pressure inside the tank 14.

In some embodiments, the seal 18 is configured to seal the opening 12 axially 28 via the interface 16 and radially 34 via the housing 22. This radial 34 seal is shown, for example, in the section 60 in FIG. 2A and 2B. In the example shown, a corresponding portion of the seal 18 that provides the radial seal slides axially along a corresponding sealing portion of the housing 22 when the housing 22 moves axially 28 relative to the seal carrier 26.

The device 10 may comprise a cover 54 coupled to the housing 22, in particular by a coupling 56, in order to transmit rotational movement of the cover 54 to the housing 22.

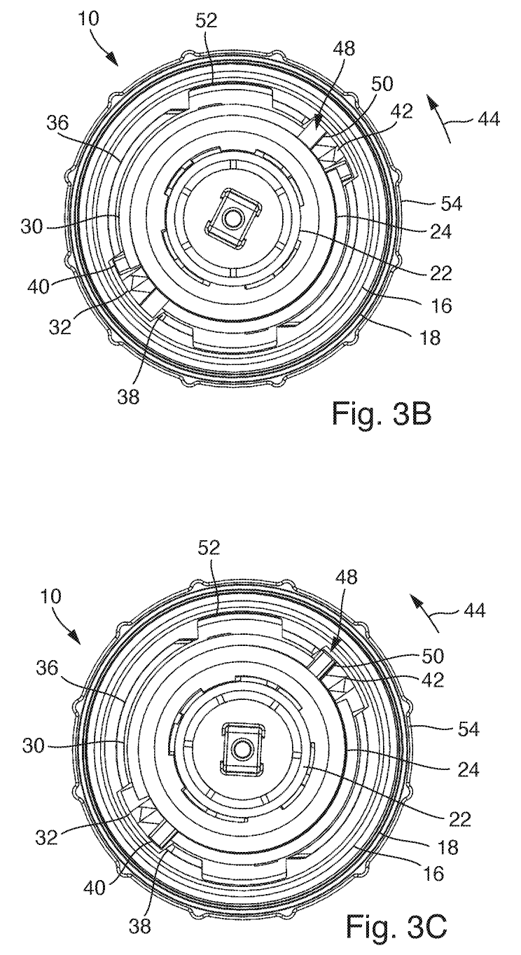

FIG. 3A to 3C show a bottom view of the device 10 in the inserted position, the hooked position and the closed position.

In some embodiments, the interface 16 is configured to receive the device 10 according to the above embodiment for sealing the opening 12. For this purpose, the interface 16 can have at least one insertion portion 52 through which the engagement portion 32 can be inserted. The insertion portion 52 can, for example, be recesses. The insertion portion 52 releases the hooked portion 36 of the interface 16 in order to be able to insert the engagement portion 32 of the pressure ring 30 into the hooked portion 36.

FIG. 3A shows the device 10 in the inserted position. The engagement portions 32 are inserted into the hooked portion 36 of the interface 16 by insertion portions 52.

FIG. 3B shows the device 10 in the hooked position. In the example shown, the device 10 is rotated from the inserted position by, for example, about 125°, whereby the engagement portion 32 extends along the hooked portion 36 to the stop 38. Up to this position, for example, all individual parts of the device 10 rotate together.

FIG. 3C shows the device 10 in the closed position. In the example shown, this position is achieved by a further rotation of, for example, an additional 24°. During this rotation, rotation of the pressure ring 30 and optionally the seal carrier 26 is blocked by the stop 38. Accordingly, the locking pin 40 extends into the closed position via the ramp 42 and the optional snap-on bead 50. The resulting relative rotation between the pressure ring 30 and the housing 22 leads to relative axial movement between the housing 22 and the seal carrier 26, by which the seal 18 is pressed against the interface 16. In other words, the locking mechanism 24 pulls the housing 22 against the interface 16, against which the seal 18 and the seal carrier 26 are pressed by the spring 20. In the closed position, the device 10 is clamped into the interface.

In the example shown in FIG. 3A to 3C, the device 10 is clamped into the interface 16 via the cover 54 by the coupling 56 on the pressure ring 30 and the locking mechanism 24. This arrangement, and in particular the locking mechanism 24 and the pressure ring 30, allows for a design in which the spring 20 and the seal carrier 26 are substantially completely enclosed by the volume of the tank 14 and accordingly also by the pressure inside the tank 14. Accordingly, the pressure in the tank 14 acts on both sides of effective surfaces of the seal carrier 26, whereby its effect on the seal carrier 26 can be substantially compensated for such that the seal carrier 26 substantially only transmits the spring force to the seal 18.

In some embodiments, the device can provide one or more advantages. For example, the spring force applied to the seal can be less sensitive to pressure within the tank, which can improve sealing reliability. The arrangement of the pressure ring, seal carrier, and housing can also reduce friction between the seal and the interface during installation or removal, which can reduce required torque and improve ease of use. In some embodiments, the device can be assembled with a relatively simple structure and can provide tactile and/or audible feedback when a closed position is reached.

To the extent not already described, the different features and structures of the various embodiments can be used in combination with, or substituted for, one another as desired. The fact that one feature is not illustrated in all embodiments should not be construed to mean that it cannot be so illustrated, but rather is done for brevity of description. Thus, the various features of the different embodiments can be mixed and matched as desired to form additional embodiments, whether or not such embodiments are expressly described. All combinations and permutations of features described herein are intended to be within the scope of this disclosure.

Persons skilled in the art will understand that the structures and methods specifically described herein and shown in the accompanying figures are non-limiting exemplary aspects, and that the description and figures should be construed merely as illustrative of such aspects. Accordingly, the present disclosure is not limited to the precise aspects described, and various other changes and modifications can be effected by one skilled in the art without departing from the scope of the present disclosure.

Additionally, the elements and features shown or described in connection with certain aspects can be combined with the elements and features of other aspects without departing from the scope of the present disclosure, and such modifications and variations are also included within the scope of the present disclosure. Accordingly, the subject matter of the present disclosure is not limited by what has been particularly shown and described.

What is claimed:

1. A device for sealing an opening of a tank, the opening comprising an interface configured to receive the device, the device comprising:
a housing;
a seal configured to seal the opening via the interface;
a seal carrier configured to receive the seal, the seal carrier being at least axially movable relative to the housing;
a spring arranged between the housing and the seal carrier and configured to press the seal against the interface by a spring force acting on the seal carrier in an axial direction; and
a pressure ring configured to move the housing axially relative to the seal carrier when the housing is rotated relative to the pressure ring, such that the spring force varies to press the seal against the interface.

2. The device of claim 1, wherein the pressure ring comprises at least one engagement portion extending radially outward and configured to engage a hooked portion of the interface by rotation of the pressure ring.

3. The device of claim 2, wherein the at least one engagement portion is configured to stop rotation of the pressure ring when the at least one engagement portion contacts a stop incorporated in the hooked portion, such that the housing rotates relative to the pressure ring.

4. The device of claim 1, further comprising a locking mechanism fixed to the housing and configured to axially couple the pressure ring to the housing.

5. The device of claim 4, wherein the locking mechanism comprises at least one locking pin extending radially outward and axially coupling the locking mechanism to the pressure ring.

6. The device of claim 5, wherein:
the pressure ring comprises at least one engagement portion extending radially outward and configured to engage a hooked portion of the interface by rotation of the pressure ring;
the engagement portion has an axially oriented contact surface;
the at least one locking pin at least partially radially overlaps the at least one engagement portion and contacts the contact surface;
the contact surface comprises a ramp having an axial slope; and
the at least one locking pin moves tangentially along the contact surface and over the ramp when the housing rotates relative to the pressure ring to move the housing axially relative to the seal carrier and vary the spring force.

7. The device of claim 6, wherein the contact surface has a snap-on bead at one end of the ramp, over which the at least one locking pin is movable when the device moves into a closed position.

8. The device of claim 1, wherein the seal is configured to seal the opening axially via the interface and radially via the housing.

9. The device of claim 1, further comprising a cover coupled to the housing by a coupling to transmit rotational movement of the cover to the housing.

10. A system comprising:
a tank comprising an opening having an interface; and
the device of claim 1,
wherein the interface is configured to receive the device for sealing the opening.
